(19) United States
(12) Patent Application Publication
(10) Pub. No.: US 2016/0120321 A1
(43) Pub. Date: May 5, 2016

(54) STORAGE SECURITY AND UTILITY DEVICE

(71) Applicant: SunSafety, LLC, Scarsdale, NY (US)

(72) Inventors: Nancy Callahan, Kihei, HI (US); Ophira Cukierman, Scarsdale, NY (US); Ilona de Jongh, New York, NY (US); Benjamin Sinclair, Pinecrest, FL (US)

(21) Appl. No.: 14/533,076

(22) Filed: Nov. 4, 2014

(51) Int. Cl. A47C 7/62; B65D 51/00; A47C 1/14; E05B 65/00; E05G 1/00

(52) U.S. Cl. CPC A47C 7/62; E05B 65/0075; E05G 1/005; A47C 1/14; B65D 51/00

(57) ABSTRACT

A device for securing physical items is disclosed. In various embodiments, the disclosed device may be attached to various objects, including lounge and beach chairs. The device may be shaped differently, depending on the configuration. In some embodiments, the device is configured to fit into already existing and unused spaces. In some embodiments, the device comprises a mounting mechanism, which may be permanent or removable. The mounting mechanism may have modifiable dimensions and/or geometry. In some embodiments, the device may provide other utility functions, such as charging. The device may include solar cells and/or an accumulator for storing energy.

### FIELD OF INVENTION

This invention relates to a device for providing secure storage and optionally additional utility functions.

### BACKGROUND

By way of background, prior to the present invention, the provision of secure storage for medium to small sized, easy to carry, items was problematic. For example, beach and pool visitors have always struggled with the best way to secure their keys for when it was time to enter the water. Keys are a noticeable item that, due to their importance, are often the subject of theft. Yet keys are difficult to take into the water because they can fall out of pockets, and the more modern, electronic, car keys will be destroyed if submerged in water. Consequently, swimmers frequently resort to simply hiding their keys in clothes or bags, in the hope that while they are swimming, a thief will not rummage through their belongings and steal the keys.

More recently, portable electronic devices have gained wide acceptance, and it is not uncommon to find smartphones, computer tablets (referred to simply as “tablets” herein), and laptop computers on a beach or near a pool. While being attractive targets for theft due to their expensive value, and being difficult to hide due to size, portable electronic devices pose other storage and security issues. For example, although a tablet may be covered by an article of clothing, and kept out of sight near a pool, it is still possible and sometimes likely that the tablet would get pushed or dropped into the water, or splashed with water by nearby swimmers. As noted above, water has a propensity to damage electronics, and therefore a suitable storage security apparatus would preferably be able to prevent water damage.

Past attempts at securing personal items have focused on providing secured storage containers, traditionally referred to as “safes.” Aside from making safes difficult to open, manufacturers of safes have traditionally focused on two security features: heavy weight and immobility. A safe's heavy weight provides a deterrent for a thief who would otherwise grab the storage container and run. For example, a container weighing several dozen lbs is not an easy one to pick up and carry out for one person. A frequent side-effect of weight is size, since safes of heavy weight also typically take up more room. As will be understood, larger objects are more difficult to hold, and are also difficult to carry while running The other security feature, immobility, is a further deterrent to removing the entire safe, and typically forces the thief to attempt to open the safe on the spot, instead of at a thief's preferred location that may have a plethora of tools designed for this purpose.

Examples of traditional safes can be found in banks and high end hotel rooms, mounted on a wall or in other carefully chosen locations. However, heavy and immobile safes are not good solutions for all locations, and are impractical at locations such as pools and beaches, as well as many other locations where large numbers of people gather. Some of the drawbacks to using heavy, or immobile, safes at a pool, for example, include the large amount of room needed to provide an adequate number of safes for pool visitors, and the difficulty faced in moving the safes around for cleaning or maintenance purposes. Moreover, if the safes are immobile, they may pose even more problems as safety hazards and also for cleaning or maintenance purposes. Therefore, there exists a need for a secure storage solution without the drawbacks of existing technology outlined above.

### SUMMARY

Generally, the present invention is a device or apparatus used to secure physical items. In one embodiment, the device is a safe that can be attached, or integrated with, other objects, including furniture. In some embodiments, the attachment or mounting mechanism may be configurable to attach to various geometries. In some embodiments, the device is shaped to accept portable electronic devices, including tablets and laptop computers. In other embodiments, the device may be shaped to accept items of different volumes and geometries.

In other embodiments, the device provides additional utility functions in addition to security. In some embodiments, the device provides a power outlet to charge portable electronic devices. In some embodiments, the device provides solar cells to collect solar energy. In some embodiments, the device provides an accumulator to store energy for later use. In some embodiments, the device provides various mechanisms for authenticating the identity of the person attempting to open or use the safe.

### BRIEF DESCRIPTION OF THE DRAWINGS

FIG. 1 illustrates an isometric view of the safe in the preferred embodiment as disclosed herein with the door closed.

FIG. 2 illustrates the front view of the safe in the preferred embodiment.

FIG. 3 illustrates the rear view of the safe in the preferred embodiment.

FIG. 4 illustrates the right view of the safe in the preferred embodiment.

FIG. 5 illustrates the left view of the safe in the preferred embodiment.

FIG. 6 illustrates the top view of the safe in the preferred embodiment.

FIG. 7 illustrates the bottom view of the safe in the preferred embodiment.

FIG. 8 illustrates an isometric view of the safe in the preferred embodiment with the door open.

FIG. 9 illustrates the front view of the safe in the preferred embodiment with the door open.

FIG. 10 illustrates the rear view of the safe in the preferred embodiment with the door open.

FIG. 11 illustrates the right view of the safe in the preferred embodiment with the door open.

FIG. 12 illustrates the left view of the safe in the preferred embodiment with the door open.

FIG. 13 illustrates the top view of the safe in the preferred embodiment with the door open.

FIG. 14 illustrates the bottom view of the safe in the preferred embodiment with the door open.

FIG. 15 illustrates an isometric view of the safe with two mounting members.

FIG. 16 illustrates the front view of the safe with two mounting members.

FIG. 17 illustrates the rear view of the safe with two mounting members.

FIG. 18 illustrates the right view of the safe with two mounting members.

FIG. 19 illustrates the left view of the safe with two mounting members.

FIG. 20 illustrates the top view of the safe with two mounting members.

FIG. 21 illustrates the bottom view of the safe with two mounting members.

FIG. 22 illustrates an isometric view of a preferred embodiment of a mounting member.

FIG. 23 illustrates the front view of a mounting member.

FIG. 24 illustrates the rear view of a mounting member.

FIG. 25 illustrates the right view of a mounting member.

FIG. 26 illustrates the left view of a mounting member.

FIG. 27 illustrates the top view of a mounting member.

FIG. 28 illustrates the bottom view of a mounting member.

FIG. 29 illustrates a preferred embodiment of the hinge mechanism connecting the body of the safe with the door.

FIG. 30 illustrates the hinge as disconnected from the body of the safe.

FIG. 31 illustrates the rear view of the safe door and hinge.

FIG. 32 illustrates an alternate view of the safe door and hinge.

FIG. 33 illustrates a view of the safe door and hinge, as connected to the body of the safe.

FIG. 34 illustrates an isometric view of the hinge axle in the preferred embodiment.

FIG. 35 illustrates the front view of the hinge axle.

FIG. 36 illustrates the rear view of the hinge axle.

FIG. 37 illustrates the right view of the hinge axle.

FIG. 38 illustrates the left view of the hinge axle.

FIG. 39 illustrates the top view of the hinge axle.

FIG. 40 illustrates the bottom view of the hinge axle.

FIG. 41 illustrates an exploded view of the safe, door, mounting members, and other components.

FIG. 42 illustrates an alternate exploded view of the safe, door, mounting members, and other components.

FIG. 43 illustrates an exploded view of the safe, door, keypad mechanism, and other components.

FIG. 44 illustrates one embodiment of the safe being attached to a lounge chair.

FIG. 45 illustrates the right view of the chair and attached safe.

FIG. 46 illustrates the left view of the chair and attached safe.

FIG. 47 illustrates the front view of the chair and attached safe.

FIG. 48 illustrates the rear view of the chair and attached safe.

FIG. 49 illustrates the top view of the chair and attached safe.

FIG. 50 illustrates the bottom view of the chair and attached safe.

FIG. 51 illustrates an alternate view of the lounge chair and attached safe.

FIG. 52 illustrates another view of the lounge chair and attached safe.

FIG. 53 illustrates an isometric view of the safe and mounting members, including dimensions in inches in the preferred embodiment.

FIG. 54 illustrates an isometric view of one embodiment of the safe including solar cells positioned on the top of the safe.

### DETAILED DESCRIPTION

Overview

Generally, the present invention is a device or apparatus used to secure physical items. For the purpose of brevity and convenience, in various embodiments, the present invention may be referred to as a safe. However, certain embodiments of the present invention provide utility functions beyond security, and are not typically referred to as a safe in the present application. It will be understood by one of ordinary skill in the art that the naming conventions used herein are not intended to narrow the scope of the present invention, but rather are used to provide an explanation of various embodiments.

Components

As noted above, one object of the present invention is to provide a safe that can be integrated with other objects. For example, the disclosed safe can preferably be positioned in tight spaces that may already exist but be presently unused. For example, in one embodiment, the disclosed safe is integrated, or mounted, underneath a pool or beach lounge chair, solving a number of problems experienced by hotel operators and visitors. The structure of various embodiments of the present invention, dimensions, and materials are described in detail below.

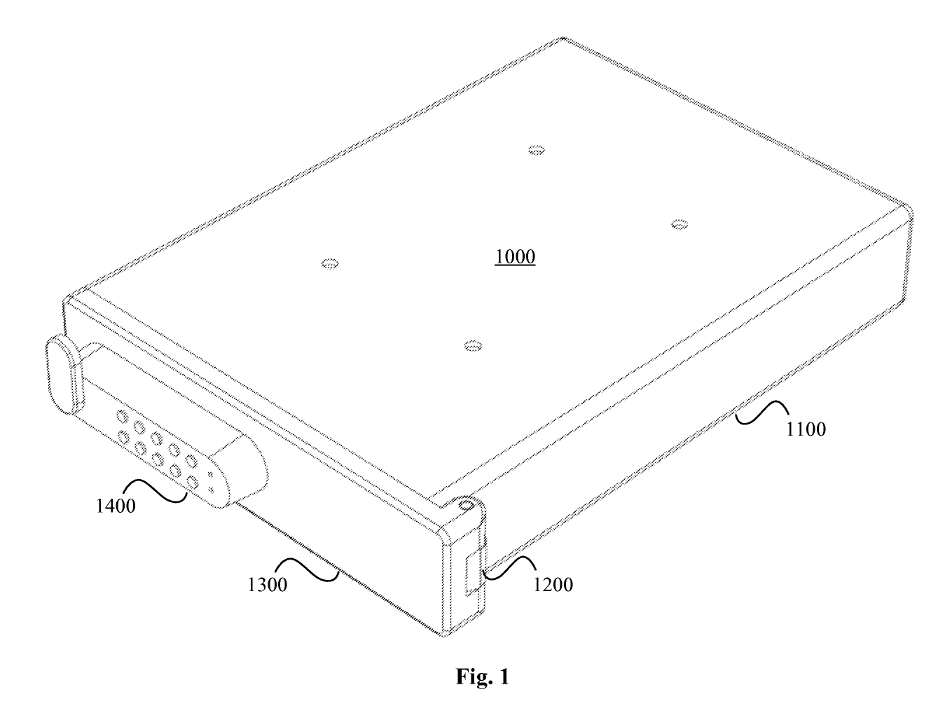

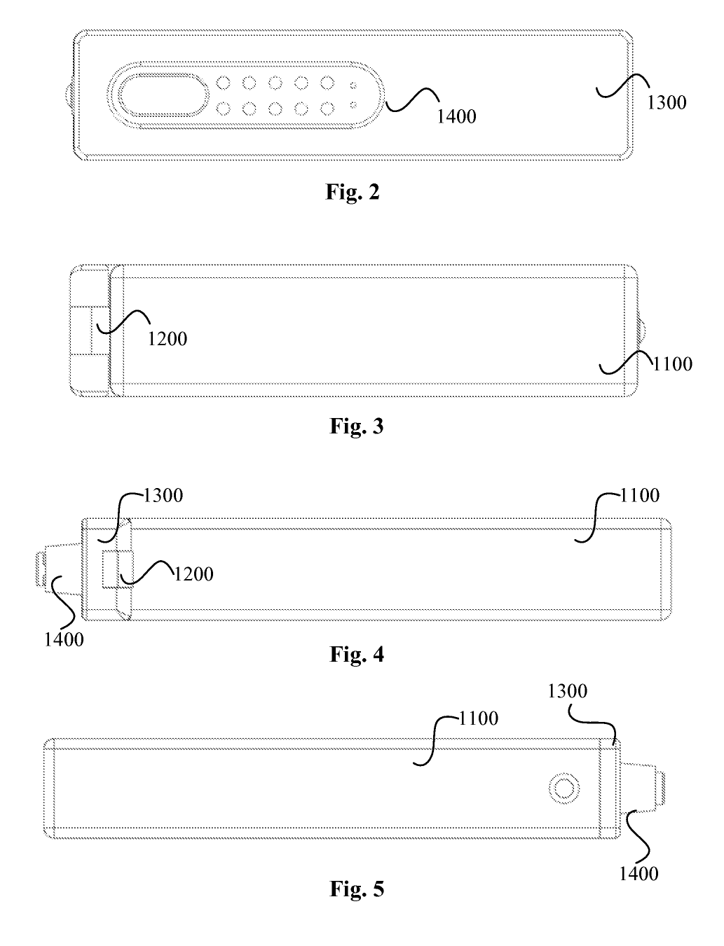

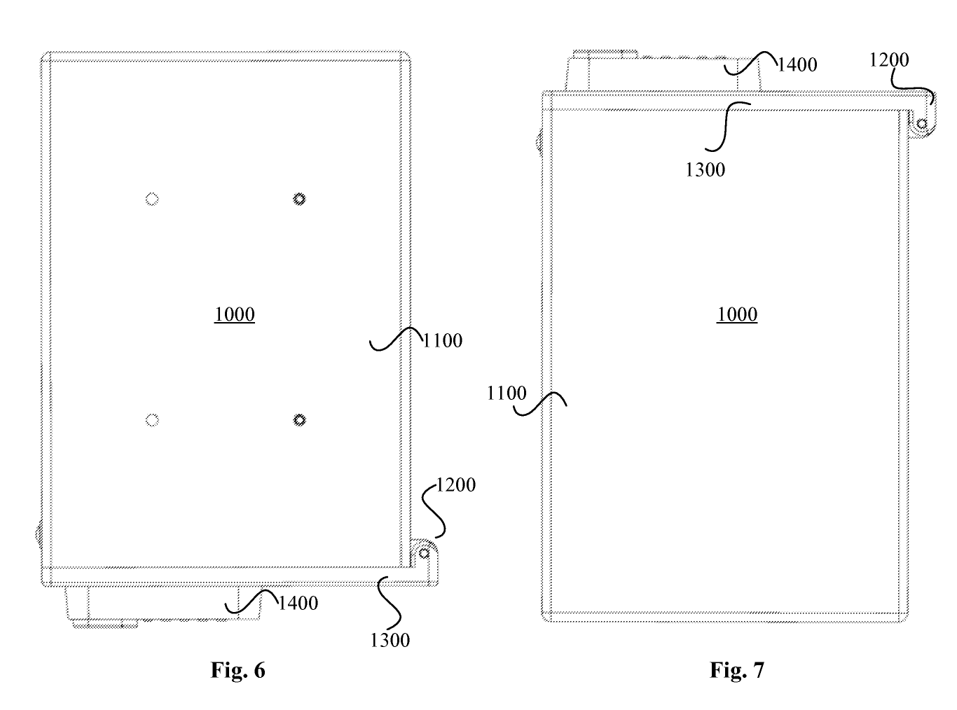

FIG. 1 shows the preferred embodiment of the safe 1000 in accordance with the present invention. In FIG. 1, safe 1000 comprises the safe body 1100 (also referred to as the enclosure), hinge mechanism 1200 (also referred to as simply the hinge), safe door 1300 (also referred to as simply the door), and keypad mechanism 1400. FIGS. 2-5 illustrate various views of the safe. FIG. 2 shows the front view of safe, including door 1300 and keypad 1400. FIG. 3 shows the rear view of safe 1000, including body 1100 and hinge mechanism 1200. FIG. 4 shows the right view of safe 1000, including body 1100, hinge mechanism 1200, door 1300, and keypad 1400. FIG. 5 shows the left view of safe 1000, including body 1100, door 1300, and keypad 1400. FIGS. 6 and 7 are top and bottom views of safe 1000, respectively, including body 1100, hinge mechanism 1200, door 1300, and keypad 1400.

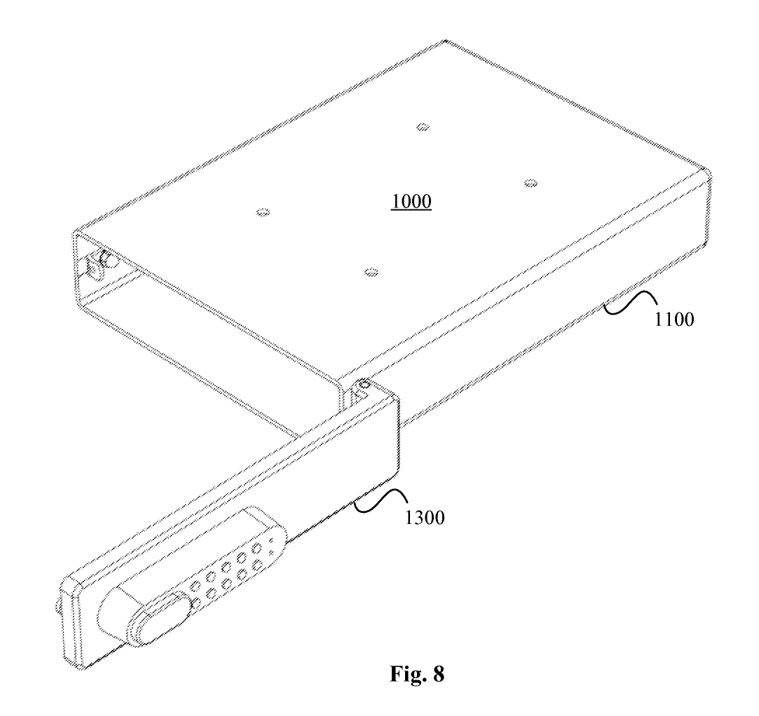

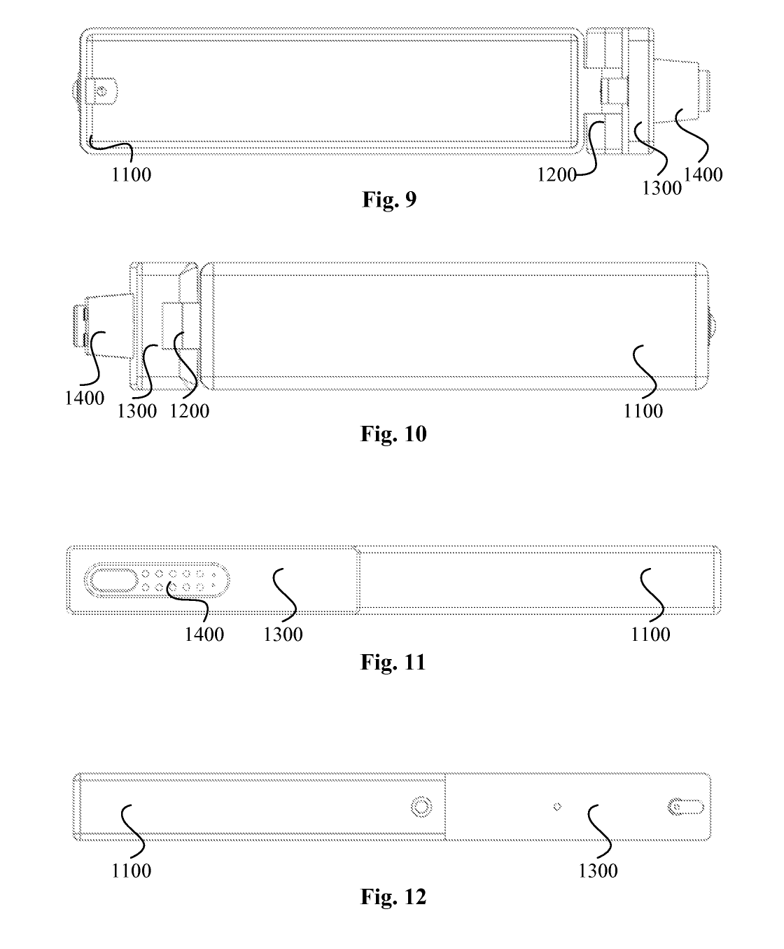

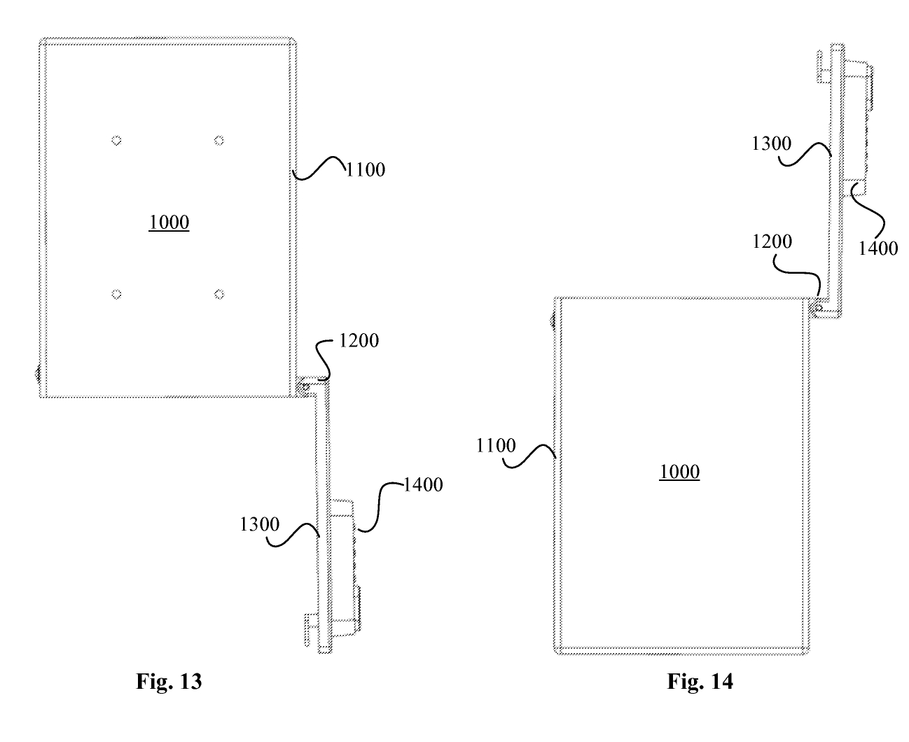

In the preferred embodiment, a user of the safe keys in a specific pattern, which can be a pass code, or a combination of buttons, to unlock the safe. FIG. 8 shows the preferred embodiment of the safe 1000 with door 1300 in the “open” position, thereby providing access to the inside of enclosure 1100. FIGS. 9-12 illustrate various views of the safe with an open door. FIG. 9 shows the front view of safe with body 1100, hinge 1200, door 1300 in the open position, and keypad 1400. In FIG. 9, access to the inside of body 1100 is possible since door 1300 is open. FIG. 10 shows the rear view of safe 1000 with body 1100, hinge 1200, door 1300 in the open position, and keypad mechanism 1400. FIG. 11 shows the right view of the safe, including body 1100, open door 1300, and keypad 1400. FIG. 12 shows the left view of the safe, including body 1100 and open door 1300. FIGS. 13 and 14 are top and bottom views of safe 1000, respectively, including body 1100, hinge 1200, open door 1300, and keypad mechanism 1400. In the illustrated embodiments, door 1300 is flat and lines up flat against the open end of body 1100. In other embodiments, the open end of body 1100 may have one or more notches, which help secure the door in the closed position. Similarly, the door may have one or more pegs to dock with the body. The notches, pegs, and/or other geometrical configurations help account for deviations that may occur in manufacturing, and ensure that the door securely mates with the body when closed. In another embodiment, body 1100 and/or door 1300 may include a weather proofing strip made from rubber, plastic, or other suitable material, to insulate the contents of the safe from the elements.

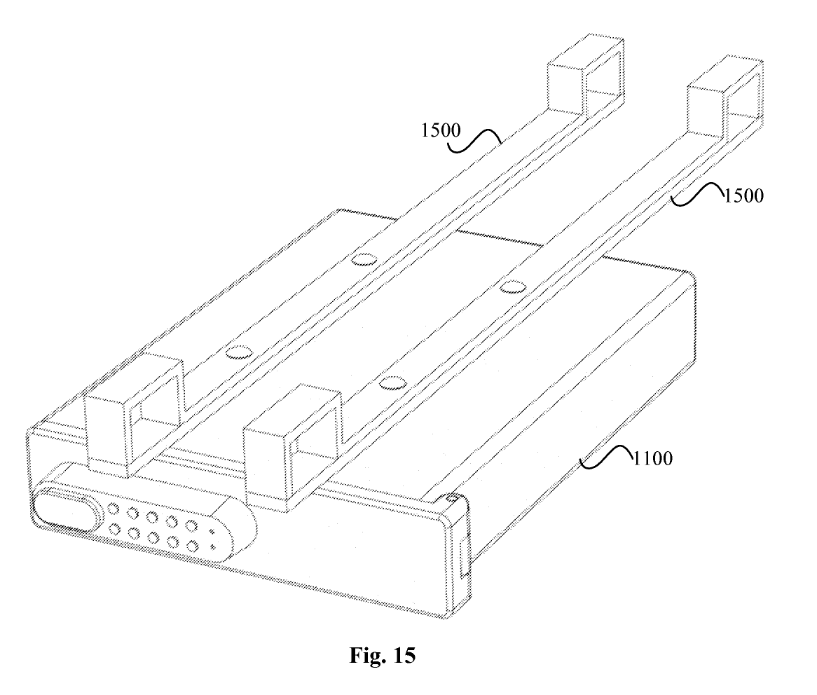

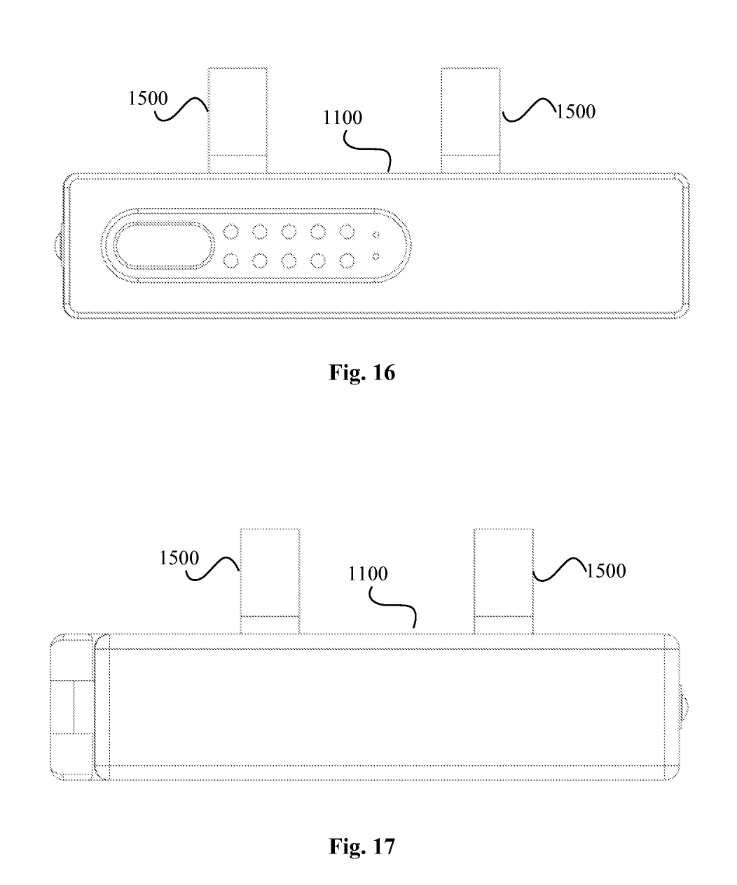

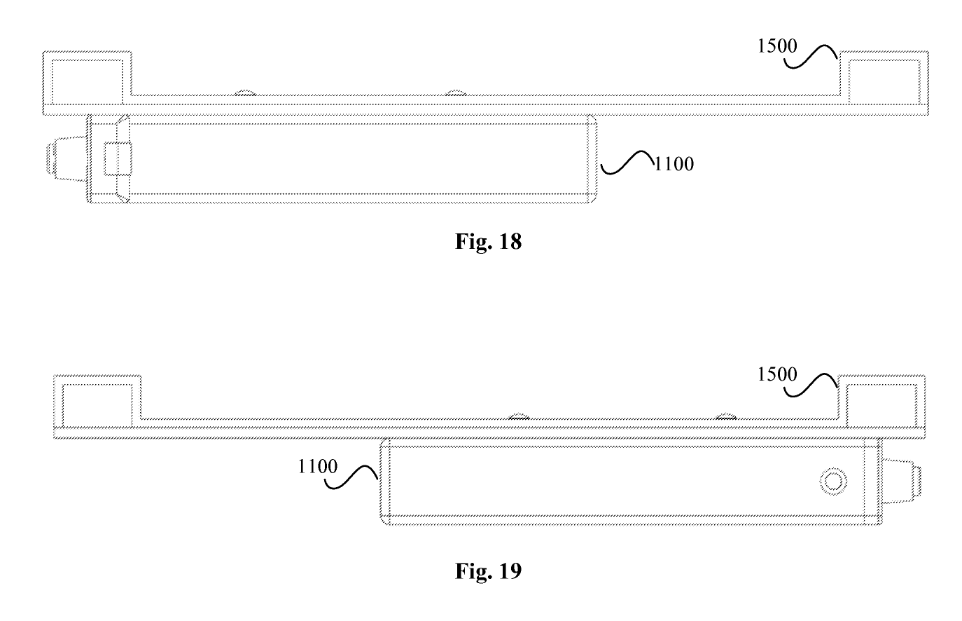

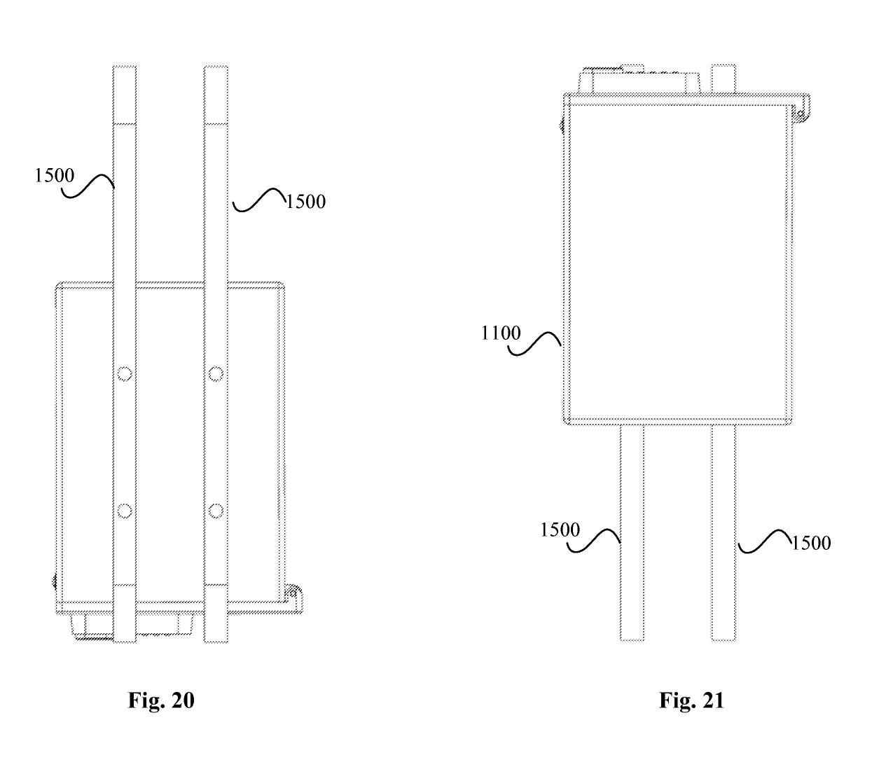

As noted earlier, one object of the present invention is to provide a mechanism for integrating, or mounting, the safe to another object such as, for example, a lounge chair. FIG. 15 illustrates the preferred embodiment of the mounting mechanism disclosed herein, including an isometric view of safe 1000, body 1100 and mounting members 1500, which are described in more detail below. FIG. 16 shows the front view of the safe body 1100 and mounting members 1500. FIG. 17 shows the rear view of the safe and mounting members 1500. FIG. 18 shows the right view of the safe, body 1100 and mounting members 1500. FIG. 19 shows the left view of the safe, body 1100 and mounting members 1500. In each of FIGS. 18 and 19, only one of the mounting members 1500 is visible, since the other mounting member is obscured by the visible mounting member. FIG. 20 shows the top view of the safe and mounting members 1500, and FIG. 21 shows the bottom view of the safe and mounting members 1500, parts of which are hidden behind safe body 1100. In various embodiments, the spacing between mounting members 1500 can be different, depending on the desired configuration and manufacturing process. In another embodiment, mounting members 1500 are movable with respect to each other, with the assistance of a sliding bracket positioned on top of the safe but orthogonally to each mounting member, such that the mounting members 1500 can be adjusted to be closer to each other, or further away from each other, as desired.

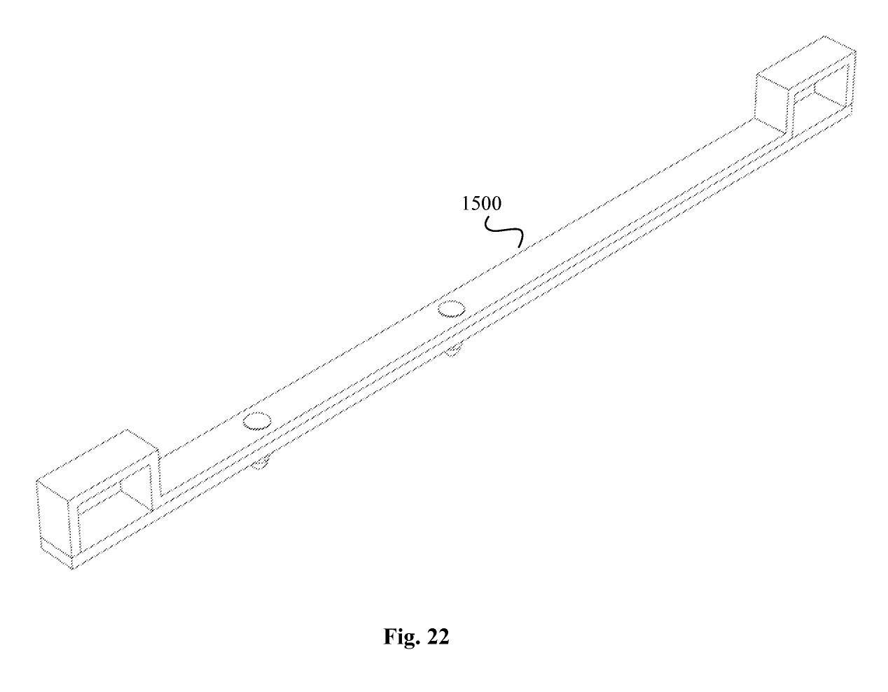

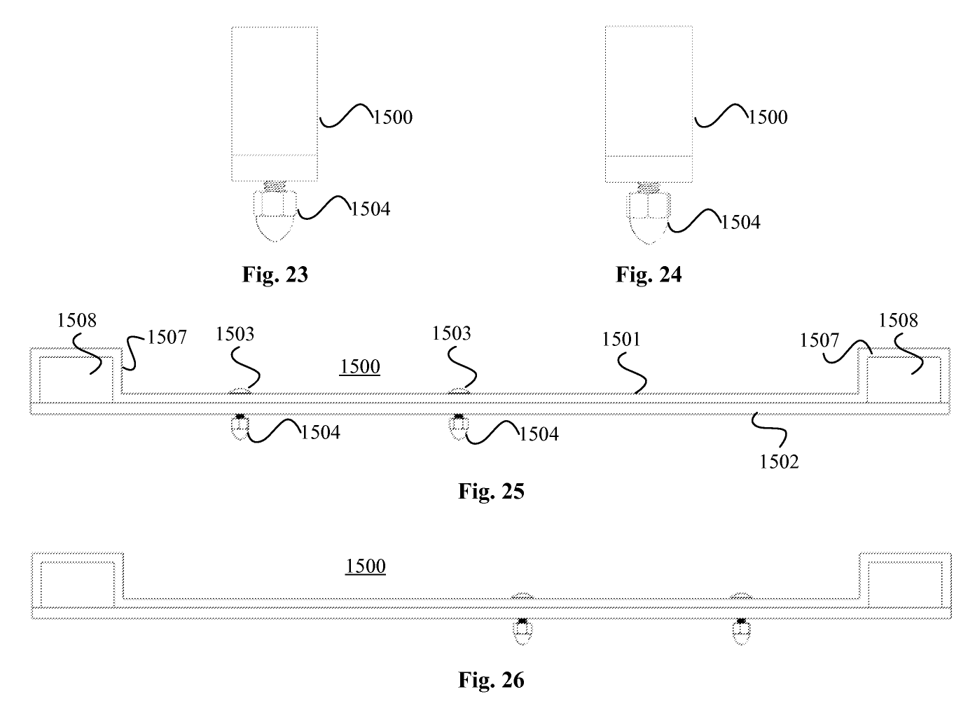

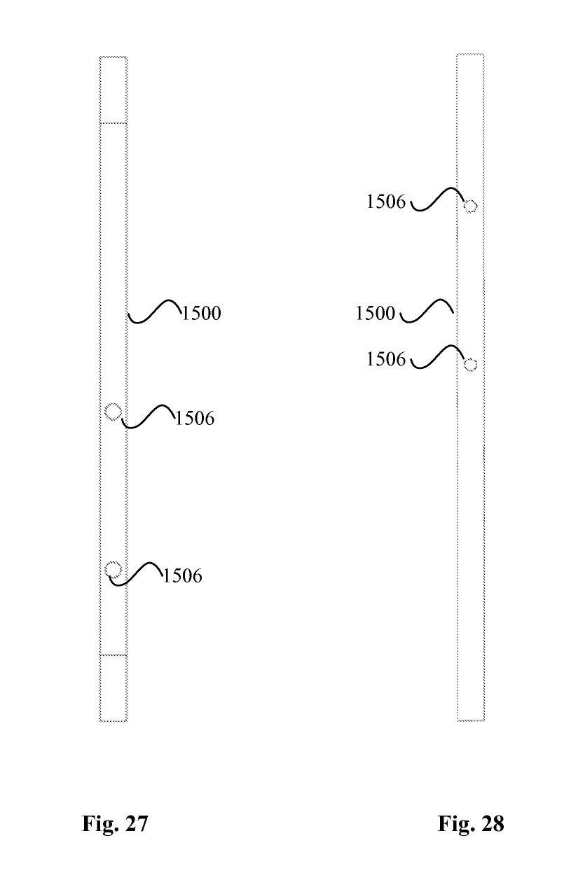

Turning to the structure of mounting members 1500, FIG. 22 illustrates an isometric view of one mounting member 1500 in the preferred embodiment. In FIGS. 23 and 24, mounting members 1500 are shown in the front view, and rear view, respectively. FIG. 25 shows the right view of mounting member 1500, which in the preferred embodiment is composed of upper member 1501, lower member 1502, bolts 1503, and nuts 1504. In FIG. 25, the ends of mounting member 1500 are configured as brackets 1507, which create space 1508 between upper member 1501 and lower member 1502. In the preferred embodiment, upper and lower members 1501 and 1502 operate as a clamp around objects to which the safe is being attached, with space 1508 illustrating the position of the object around which the clamp is formed. FIG. 26 shows the left view of mounting member 1500 illustrated in FIG. 25. In FIG. 26, the only visible difference as compared to FIG. 25 is the location of nuts 1504 and bolts 1503, due to the preferred placement of the safe closer to one side of the lounge chair as described in more detail below. FIG. 27 shows the top view of mounting member 1500 and openings 1506, and FIG. 28 shows the bottom view of mounting member 1500 and openings 1506. It should be noted that in FIG. 28, openings 1506 have a hexagonal shape. The purpose of the hexagonal shape is to allow a hexagonal nut to be inserted into the opening and remain in place without additional equipment required while the bolt is lowered into opening 1506 from the top and screwed into the nut. This allows for easier assembly of the safe and mounting mechanism in the preferred embodiment, but other embodiments, where opening 1506 in FIG. 28 is of circular shape are also possible.

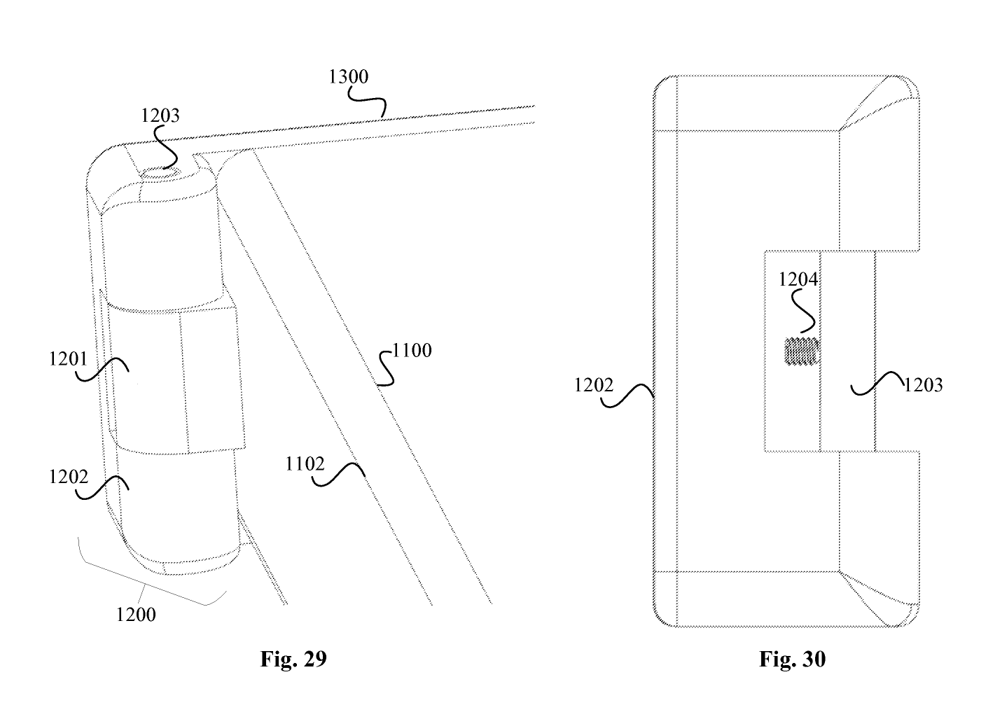

Turning back to the safe 1000, FIGS. 29-40 illustrate hinge mechanism 1200 in more detail. FIG. 29 shows safe body 1100 and door 1300 connected by hinge mechanism 1200 from a rear/right-side vantage point. As illustrated in FIG. 29, in the preferred embodiment, hinge mechanism 1200 comprises support 1201, hinge 1202, and hinge axle 1203. In the illustrated embodiment, support 1201 is part of body 1100, but one of ordinary skill in the art will recognize that support 1201 may also be attached to body 1100 via a variety of conventional means. Similarly, hinge 1202 is part of door 1300, but it can be attached to the door by conventional means. Axle 1203 facilitates the rotation of hinge 1202 with respect to support 1201. In the embodiment illustrated in FIG. 29, the hinge mechanism 1200 appears on the outside of, and protrudes from, safe body 1100. In another embodiment, hinge mechanism 1200 does not protrude from safe body 1100, and instead is built into the wall 1102 of body 1100. In another embodiment, hinge mechanism 1200 is mounted to the inside of wall 1102, with any adjustments, if needed, being made to hinge mechanism 1200 to account for the different position.

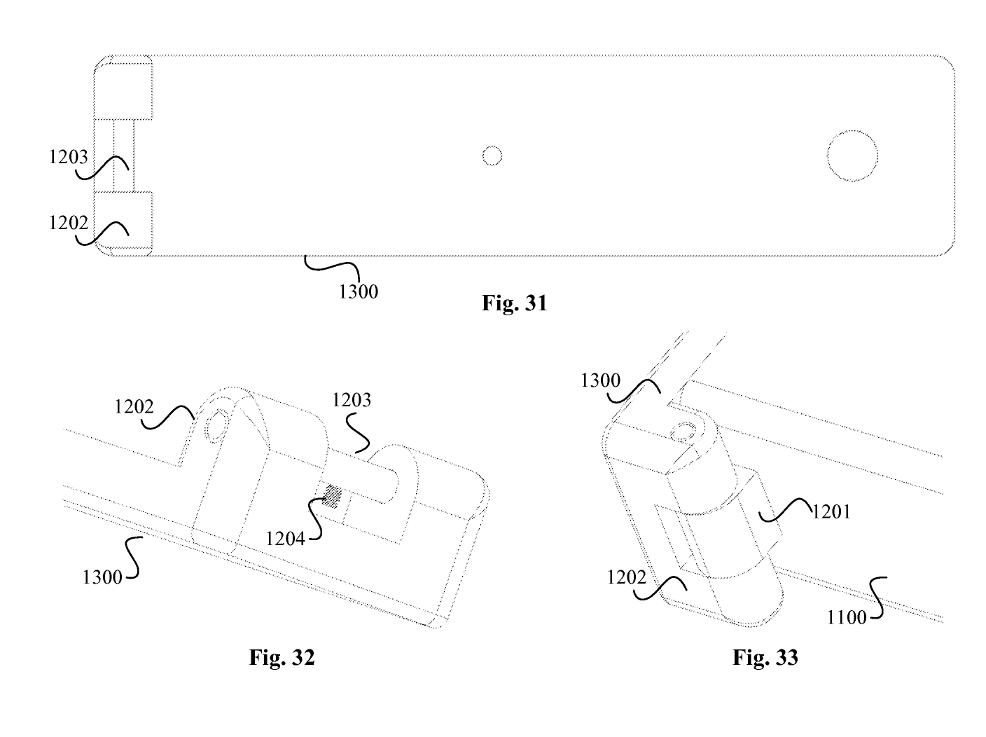

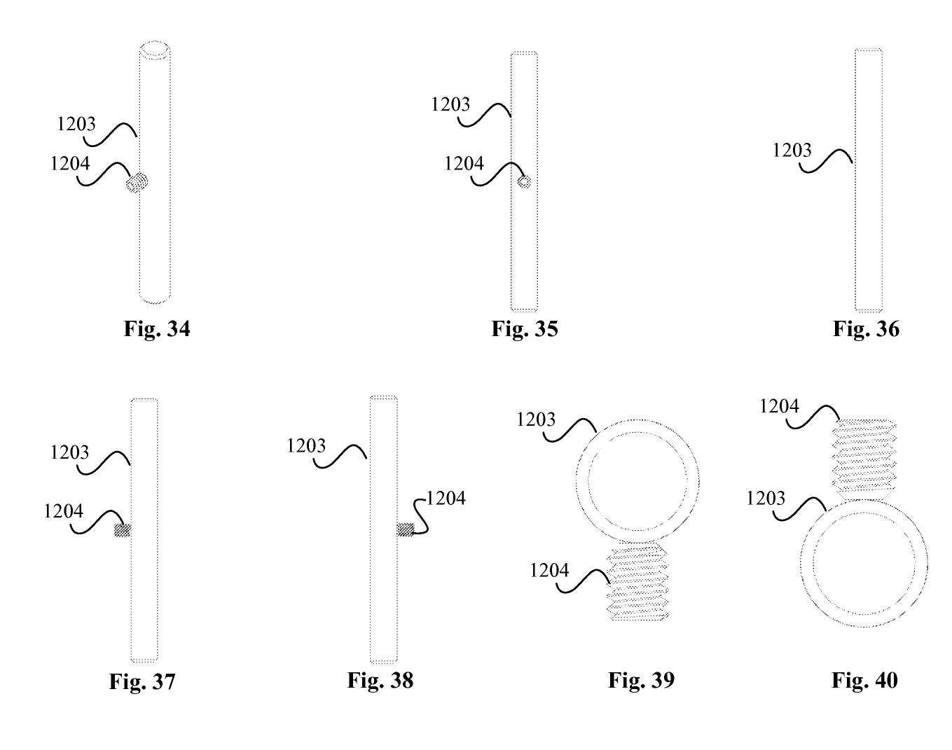

FIG. 30 is a view of hinge 1202 and axle 1203, which includes thread 1204, as seen from the right of the safe. FIG. 31 shows the rear view of door 1300, hinge 1202, and axle 1203. In FIG. 31, thread 1204 is not visible, since it is positioned in the same direction as in FIG. 30—facing the front of the safe. FIG. 32 shows a rotated view of door 1300, hinge 1202, axle 1203, and protruding thread 1204. FIG. 33 shows a close-up view of door 1300 and hinge 1202 mated to body 1100 and support 1201. FIGS. 34-40 show axle 1203 and protruding thread 1204 from isometric, front, rear, right, left, top, and bottom perspectives, respectively. While in the preferred embodiment, safe body 1100 and door 1300 are connected by hinge mechanism 1200, in other embodiments the door may be a sliding door that slides away (left, right, top, and/or bottom) to reveal the opening, folds away to reveal the opening, or rotates in a different plane to reveal the opening.

Assembly

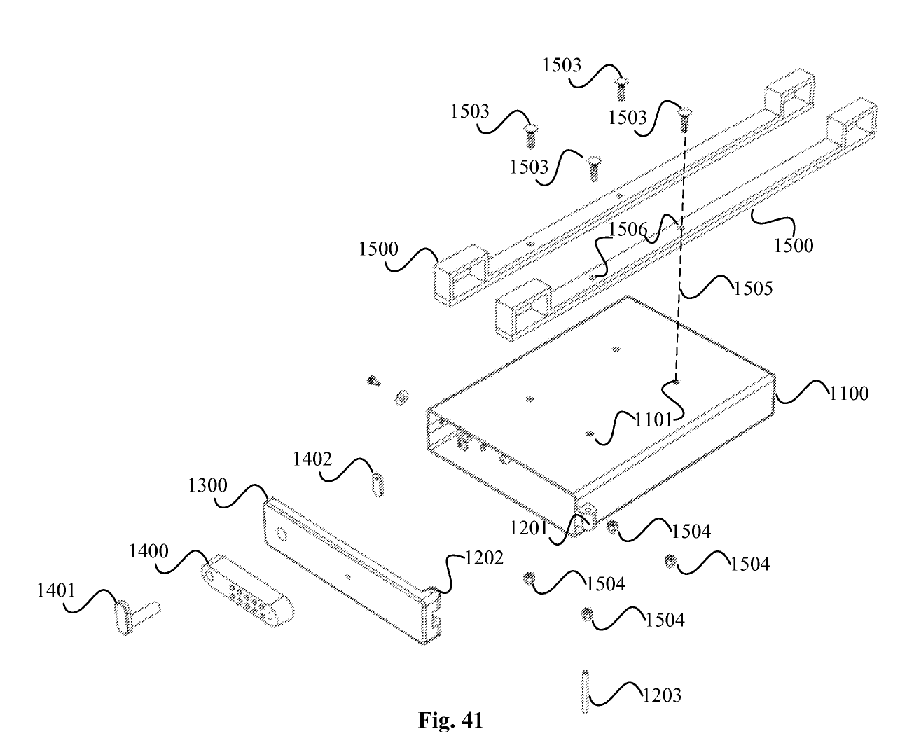

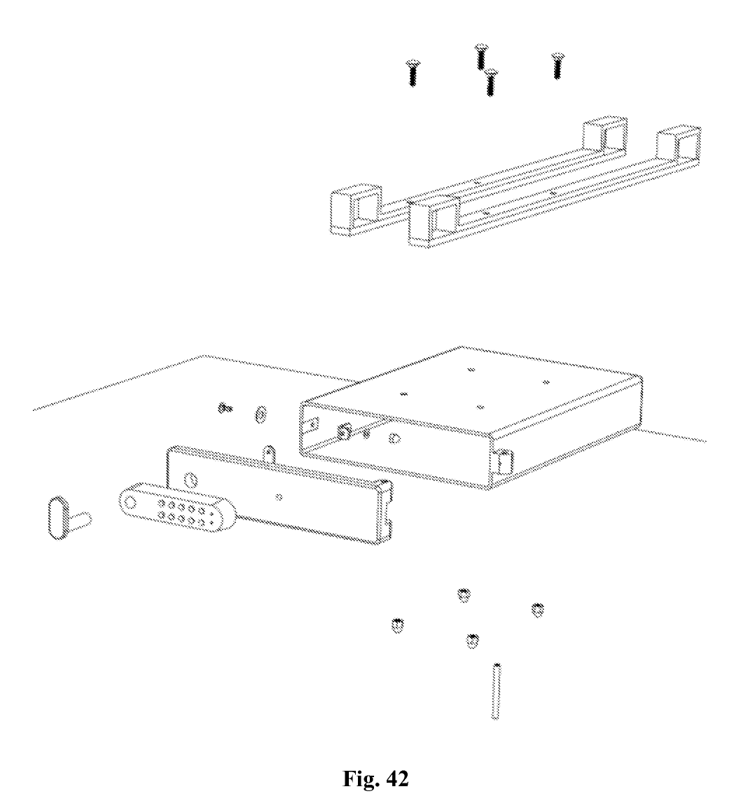

FIG. 41 shows an exploded view of previously described components, including safe body 1100, hinge support 1201, hinge 1202, axle 1203, door 1300, keypad mechanism 1400, mounting members 1500, bolts 1503 and nuts 1504. Also shown are handle 1401 and locking arm 1402 used to secure the door when the locking mechanism is engaged. In the preferred embodiment, to complete assembly of the safe and mounting kit, body 1100 and the illustrated openings 1101 are lined up to mounting members 1500 and illustrated openings 1506 along axes 1505. Bolts 1503 are then inserted into openings 1506 along axes 1505, and nuts 1504 are screwed onto the threads of bolts 1503 and tightened, thereby securing mounting members 1500 to the top of safe body 1100. FIG. 42 shows another exploded view from a slightly different, more front-positioned perspective. Although, as shown here, in the preferred embodiment the mounting members are attached to the top of the safe, in other embodiments the one or more mounting members can be attached to other sides of the sides, including, for example, the right and left sides.

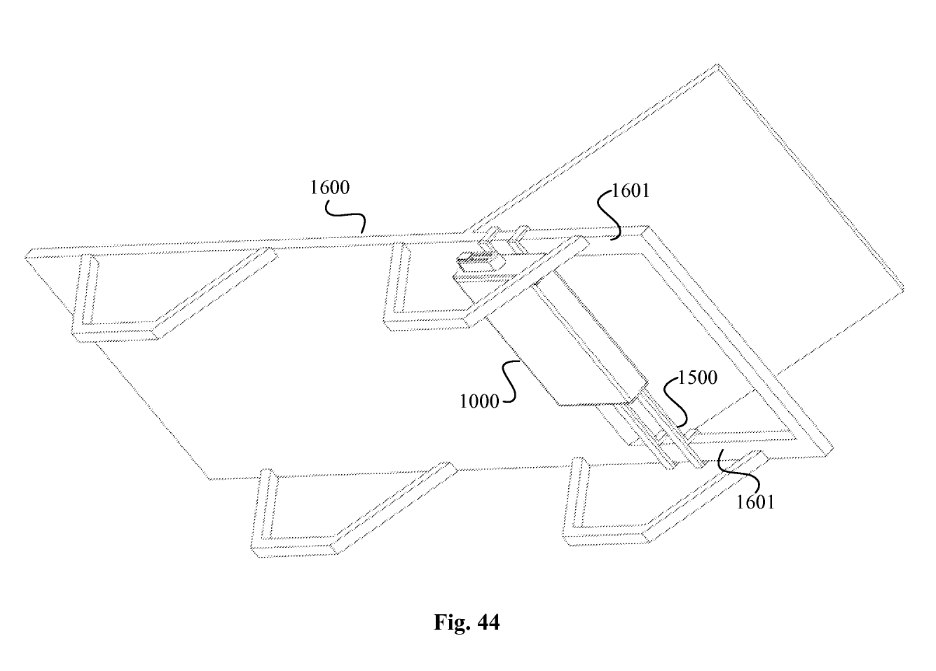

In order to provide a more detailed description of how safe 1000 is mounted to another object, such as a lounge chair, reference is made herein to FIGS. 25 and 44. In FIG. 44, the safe 1000 can be seen as mounted to a lounge chair 1600 by mounting members 1500. In FIG. 25, mounting member 1500 is shown as comprising two main components: upper member 1501 and lower member 1502. In the preferred embodiment, as illustrated in FIG. 44, when mounting the safe onto the lounge chair, upper member 1501 is positioned on top of side rails 1601 of the lounge chair. This way, brackets 1507 at the ends of mounting members 1500 allow upper mounting member 1501 and lower mounting member 1502 to clamp around side rails 1601 of the lounge chair.

In other embodiments of the present invention, the mounting mechanism may be different. For example, mounting members 1500 may be made of a single body instead of two members 1501 and 1502. In this embodiment, the ends of mounting members 1500 may provide other attachment mechanisms, such as clamps. The clamps may be configured to attach to, or be pre-manufactured in the shape of, objects of various geometries, including objects with rectangular, circular, oval, or irregular cross-sections. In other embodiments, the safe and mounting mechanism may be manufactured together with the object to which it is attached, such as a lounge chair. In this embodiment, the safe may be non-removable from the lounge chair, or it may provide for a removal mechanism. In other embodiments, the mounting members, including illustrated members 1500 may be of extendible length, so as to accommodate objects, such as lounge chairs, of various width and length.

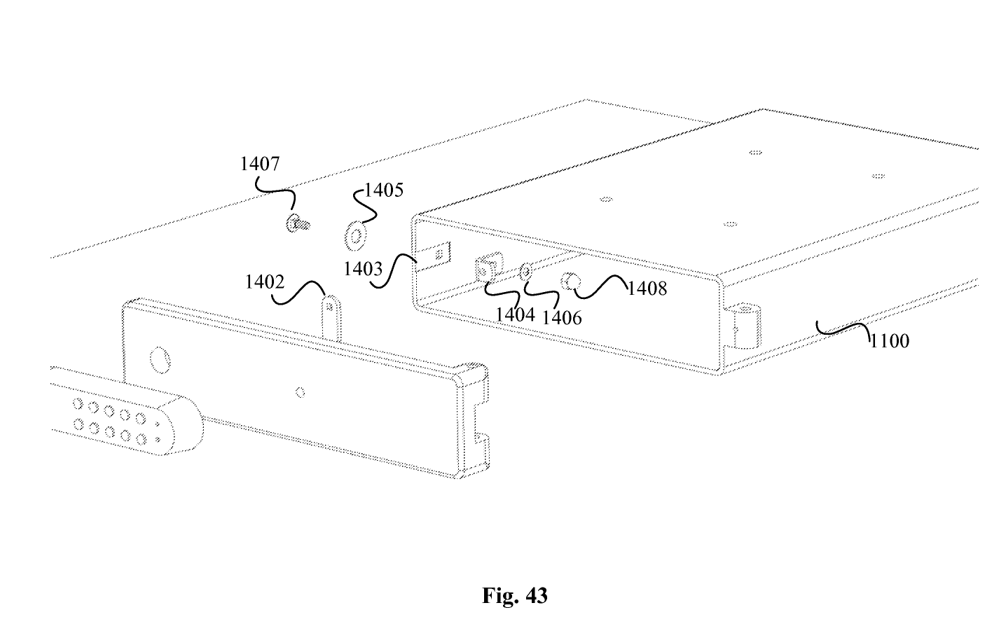

FIG. 43 illustrates a close-up, exploded view of the preferred embodiment of the locking mechanism of the safe. In FIG. 43, bracket 1404 is attached to body 1100 at groove 1403 with nut 1408 and bolt 1407, with washers 1405 and 1406 being positioned on the external and internal sides of body 1100, respectively. Safe body 1100 can be a single piece, or it may be a combination of several pieces. For example, for easier manufacturing of the safe in various embodiments, body 1100 may be assembled from two “claim shell” parts.

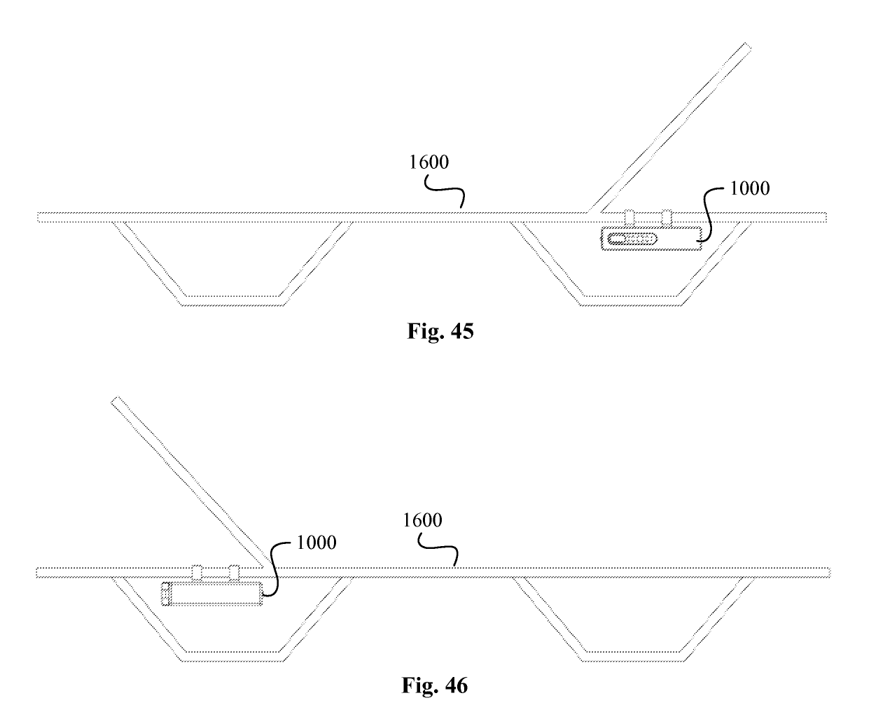

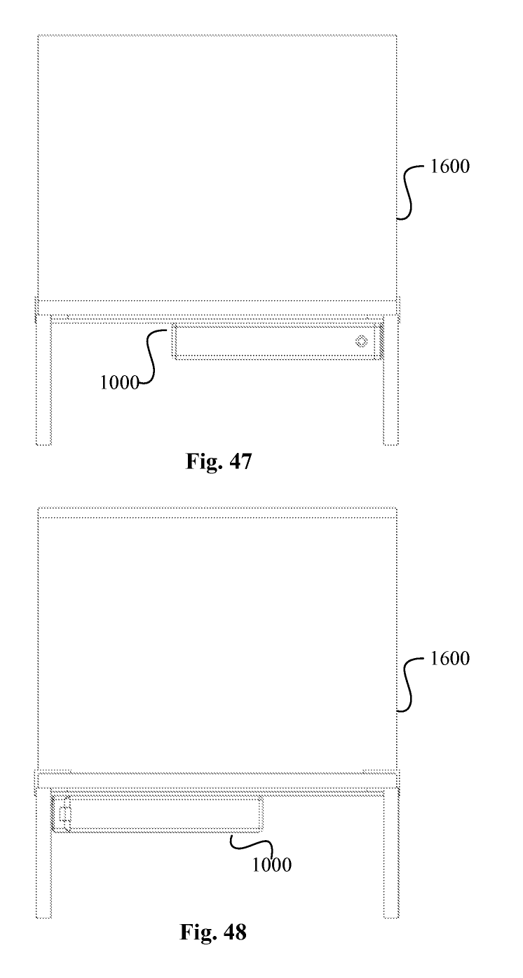

As noted earlier, one advantage of the present invention is the ability to mount the safe onto another object, such as a lounge chair. This configuration is illustrated in FIGS. 44-52. FIG. 44 shows safe 1000 attached to the underside of a lounge chair 1600 by mounting members 1500. FIG. 45 shows the right side of lounge chair 1600 and the front face of attached safe 1000. FIG. 46 shows the left view of lounge chair 1600 and the rear side of attached safe 1000. FIG. 47 shows the front view of lounge chair 1600 and the left side of safe 1000 attached underneath the lounge chair. In the embodiment shown in FIG. 47, safe 1000 is positioned close to one side of the lounge chair (the right side from the perspective of the viewer, but the left side from the perspective of a person sitting in the chair). This arrangement provides for easy access to the door of the safe. It will be understood by one of ordinary skill in the art that the safe may be positioned facing the other side of the lounge chair, or offset at a certain depth away from the sides, for various purposes, including convenience, ease of access, maintenance, and security. FIG. 48 shows the rear side of lounge chair 1600 and attached safe 1000.

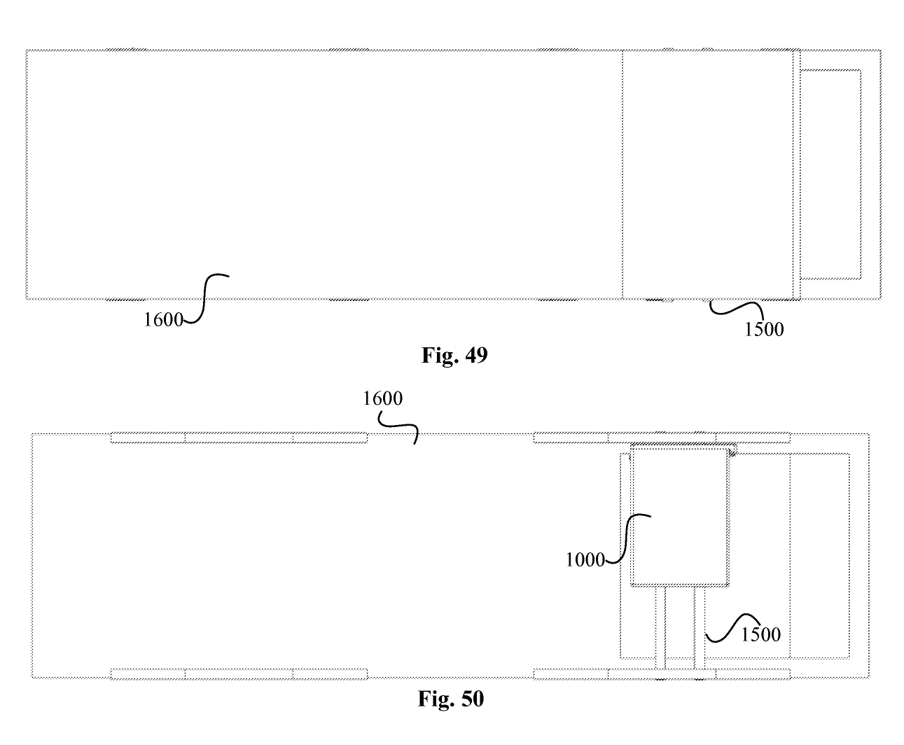

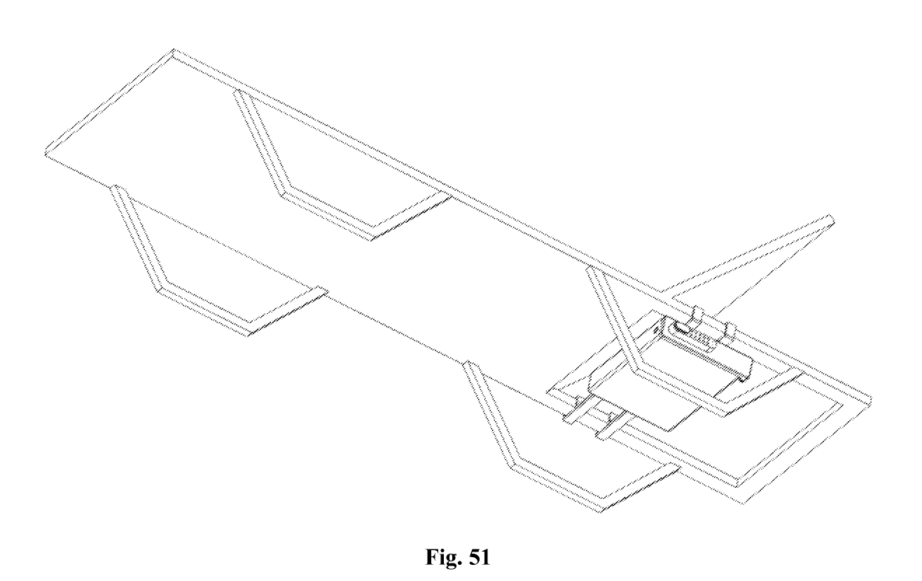

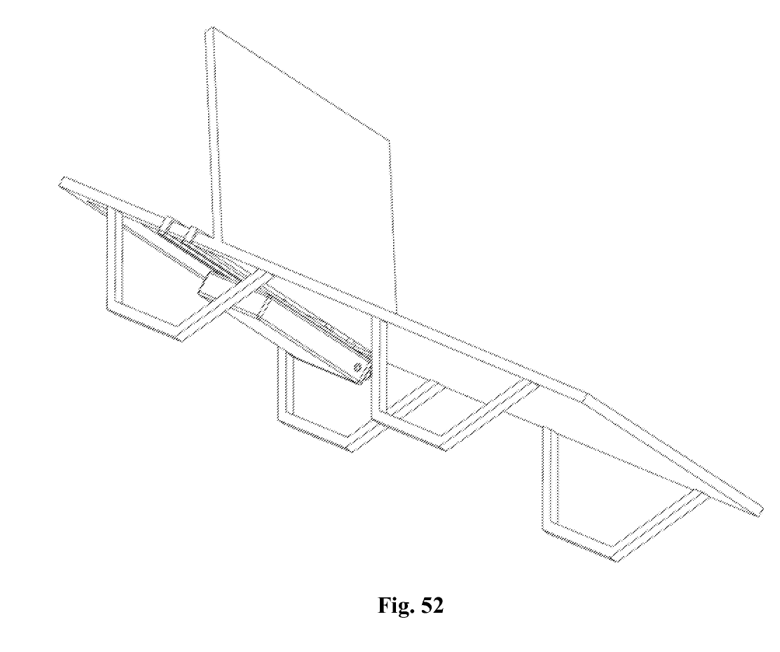

FIG. 49 shows the top side of lounge chair 1600. In this embodiment, the attached safe is not visible, but edges of mounting members 1500 can be seen protruding from the sides of the lounge chair. FIG. 50 shows the bottom side of lounge chair 1600. Here, attached safe 1000 is visible, including mounting members 1500. FIGS. 51 and 52 show the lounge chair and attached safe from different viewpoints. It will be understood that while, in the preferred embodiment, two mounting members are used to attach the safe, in other embodiments varying numbers of mounting members may be used depending on the circumstances.

Materials

The safe and mounting members disclosed herein may be constructed of different materials in various embodiments. The safe body 1100 and door 1300 may be made from, for example, Polypropelene (preferably with a UV inhibitor) (“PP”), Acrylonitrile butadiene styrene (“ABS”), Polyethynyl (High Density or Low Density, “HDPE” or “LDPE”), Polyvinyl Chloride (“PVC”), and/or Fiberglass. Other composite materials may also be used to manufacture various components of the present invention. The above materials are relatively light, and can be useful in an environment where the safe is mounted to a movable object, such as a lounge chair. However, it in other embodiments the safe and door may be manufactured from aluminum, steel, or iron. The door and safe body may comprise several layers of materials, and may be fire retardant. The mounting members 1500 are preferably manufactured from aluminum or steel, although other materials are possible.

Dimensions

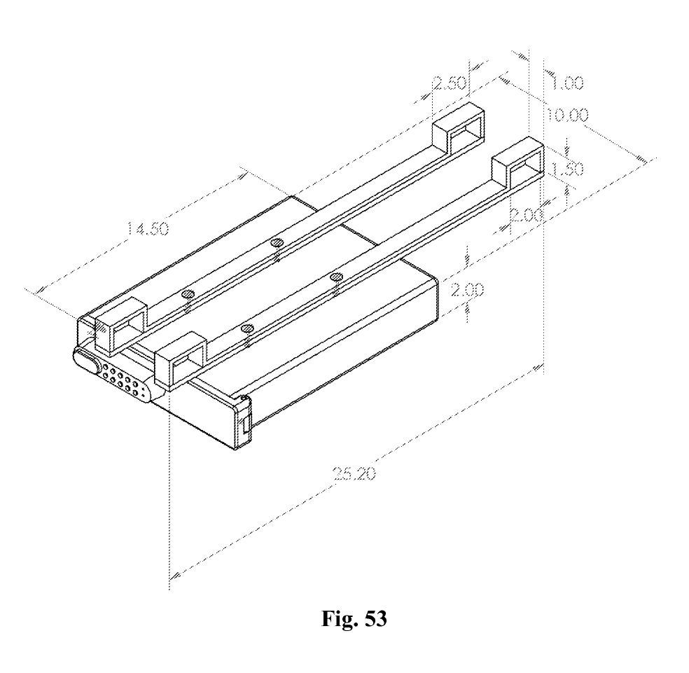

The dimensions of the safe and mounting members in the preferred embodiment are illustrated in FIG. 53, in inches. As noted earlier, in other embodiments of the present invention, the dimensions can be different. For example, the mounting members may be sized to fit chairs, or other objects of greater or smaller dimensions than shown, by way of example, in FIGS. 44-52. The mounting members may also have different mounting ends, of circular, triangular, or other shape (as opposed to the rectangular shape 1508 in FIG. 25) to connect to differently shaped objects. Similarly, the mounting ends may include a clamp, or a vise type mechanism, for various methods of mounting the safe. In other embodiments, the safe itself may be differently sized, including for example stretching to fit a longer or shorter portion of the lounge chair. All three dimensions in terms of height, width, and depth of the safe can be adjusted depending on the environment the safe is designed to fit in. One of ordinary skill in the art will recognize that the dimensions provided in FIG. 53 are not designed to limit the present invention, but rather provide an illustration of the preferred embodiment.

Utility Features

As noted earlier, one object of the present invention is to provide additional utility features in addition to providing security for physical items. One of the utility features contemplated herein is the provision of an electrical outlet, or more specifically, a charging mechanism, that could be used with electronic devices stored inside the safe. Thus, for example, when a safe, as disclosed in several embodiments herein, is mounted to a lounge chair located next to a pool, a pool visitor may choose to store their phone or tablet inside the safe. In one embodiment, the safe would include a charging mechanism that could charge an electronic device, such as a phone or tablet.

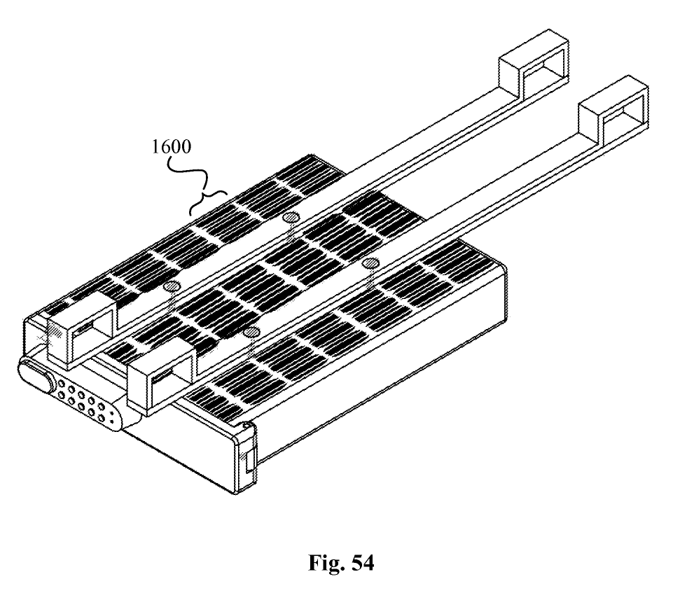

In the preferred embodiment, the charging device would have a cable designed to interface with a portable electronic device through one or more of USB, micro-USB, Apple Lightning, Firewire, or other connectors. Whereas the connector would interface with the electronic device, the other end of the cable would be connected to a power source. The power source can be one, or a combination, of various mechanisms for providing power, including a battery, electrical outlet, accumulator, or a device designed to convert solar power to usable electricity. One embodiment of a solar-powered charging mechanism is illustrated in FIG. 54. In FIG. 54, the top of the safe described elsewhere in the specification is covered by a layer of solar cells 1600. Solar cells 1600 are connected to a circuit, not shown in FIG. 54, that converts electricity generated by solar cells 1600 into a voltage and current usable to charge electronic devices. The output of the circuit may be connected directly to the charging cable noted earlier, or it can be connected to an accumulator for storage in a rechargeable battery or an accumulator for subsequent use later on.

In other embodiments, the present invention provides additional utility features, such as alternative ways of authenticating the user. In the preferred embodiment, users access the safe by entering a code into keypad mechanism 1400, shown, for example, in FIG. 1. In other embodiments, users may access the safe through a fingerprint reader, by voice recognition, or by lock and key. It will be understood that other methods of, or combinations of methods of, user authentication are contemplated herein. In other embodiments, the safe may include a Wi-Fi or other antenna to provide voice and/or data coverage to the surrounding area, with the data link being provided by a hotel through ordinary wired (for example an Ethernet cable connected to the safe) or wireless (Wi-Fi, Bluetooth, or other) communication methods. To the extent that electric power is required for any utility or security features disclosed herein, such as, for example, if the keypad mechanism requires power or includes a display, the required electric power could be provided by connecting the safe to an electric power outlet, or by including a battery inside the safe and/or keypad. The included battery may be rechargeable.

The foregoing description of the various and preferred embodiments of the present invention has been presented for purposes of illustration and explanation. It is not intended to be exhaustive nor to limit the invention to the specifically disclosed embodiments. The embodiments herein were chosen and described in order to explain the principles of the invention and its practical applications, thereby enabling others skilled in the art to understand and practice the invention. However, many modifications and variations will be apparent to those skilled in the art, and are intended to fall within the scope of the invention, claimed as follows.

What is claimed is:

1. A device for securing physical items, comprising:
an enclosure for securing physical items, the enclosure having an opening;
a door for closing the opening, wherein the door is mounted on a hinge, and wherein the hinge is mounted on the enclosure; and
one or more mounting members, wherein the one or more mounting members are attached to the top of the enclosure, wherein each of the one or more mounting members comprises a linear component and two ends, and wherein each end of the one or more mounting members is configured to attach to another object.

2. The device of claim 1, further comprising a locking mechanism, wherein the locking mechanism secures the door to the enclosure thereby closing said opening.

3. The device of claim 2, wherein the locking mechanism comprises an electronic keypad.

4. The device of claim 2, wherein each of the one or more mounting members comprises an upper mounting member component and a lower mounting member component.

5. The device of claim 4, wherein each of the two ends is shaped to attached to a beam.

6. The device of claim 5, wherein the beam has a substantially rectangular cross-section.

7. The device of claim 4, wherein the enclosure for securing physical items is made from one or more of: Polypropelene (“PP”), Acrylonitrile butadiene styrene (“ABS”), Polyethynyl (High Density or Low Density, “HDPE” or “LDPE”), Polyvinyl Chloride (“PVC”), and/or Fiberglass.

8. The device of claim 1, further comprising a charging cord configured to connect to an electronic device.

9. The device of claim 8, further comprising one or more solar cells positioned on the enclosure.

10. A device for securing physical items, comprising:
a means for securing physical items, the means for securing physical items having an opening;
a closing means for closing the opening,
a mounting means for mounting the closing means onto the means for securing physical items; and
one or more mounting means for mounting the means for securing physical items to another object, wherein each of the one or more mounting means comprises a linear component and two ends, and wherein each end of the one or more mounting means is configured to attach to another object.

11. The device of claim 9, further comprising a locking means, wherein the locking means secures the closing means to the means for securing physical items, thereby closing said opening, wherein the locking means comprises an electronic keypad.

12. The device of claim 11, wherein each of the one or more mounting means comprises an upper mounting means component and a lower mounting means component.

13. The device of claim 12, wherein the means for securing physical items is made from one or more of: Polypropelene (“PP”), Acrylonitrile butadiene styrene (“ABS”), Polyethynyl (High Density or Low Density, “HDPE” or “LDPE”), Polyvinyl Chloride (“PVC”), and/or Fiberglass.

14. The device of claim 9, further comprising a means for charging an electronic device.

15. A lounge chair with a security device, comprising:
a lounge chair;
an enclosure for securing physical items, the enclosure having an opening and a door used to secure said opening;
wherein, the enclosure is attached to the lounge chair with one or more mounting members, and wherein the one or more mounting members are attached to the top of the enclosure, wherein each of the one or more mounting members comprises a linear component and two ends, and wherein each end of the one or more mounting members is configured to attach to the lounge chair.

16. The lounge chair of claim 15, further comprising a locking mechanism, wherein the locking mechanism secures the door to the enclosure thereby closing said opening, and wherein the locking mechanism comprises an electronic keypad.

17. The lounge chair of claim 16, wherein each of the one or more mounting members comprises an upper mounting member component and a lower mounting member component.

18. The lounge chair of claim 17, wherein the lounge chair has a frame, and wherein each of the two ends is shaped to attach to the frame of the lounge chair.

19. The lounge chair of claim 18, wherein the frame of the lounge chair has a rectangular cross-section.

20. The lounge chair of claim 18, wherein the enclosure for securing physical items is made from one or more of: Polypropelene (“PP”), Acrylonitrile butadiene styrene (“ABS”), Polyethynyl (High Density or Low Density, “HDPE” or “LDPE”), Polyvinyl Chloride (“PVC”), and/or Fiberglass.
